(19) United States
(12) Patent Application Publication
(10) Pub. No.: US 2025/0365790 A1
(43) Pub. Date: Nov. 27, 2025

(54) DYNAMIC WIRELESS NETWORK WITH DATA OFFLOADING

(71) Applicant: Charter Communications Operating, LLC, St. Louis, MO (US)

(72) Inventors: Vishal Chopade, Castle Pines, CO (US); Mohamed Daoud, Aurora, CO (US); Hossam Hmimy, Aurora, CO (US); Hany Heikal, Aurora, CO (US)

(73) Assignee: Charter Communications Operating, LLC, St. Louis, MO (US)

(21) Appl. No.: 18/671,014

(22) Filed: May 22, 2024

(51) Int. Cl. H04W 76/14; H04W 88/06

(52) U.S. Cl. CPC H04W 76/14; H04W 88/06

(57) ABSTRACT

Vehicles having WiFi and Bluetooth capabilities, e.g., parked in a garage, establish a wireless network architecture in which a first vehicle has access to the outside world via a direct WiFi connection to a WiFi access point (AP) and one or more other vehicles have access to the outside world via one or more vehicle-to-vehicle Bluetooth connections and the first vehicle's direct WiFi connection. In this way, all of the vehicles have outside-world access even when most of the vehicles have no direct WiFi access, thereby enabling all of the vehicles to access the outside world using WiFi instead of their cellular capabilities. The WiFi equipment can orchestrate the vehicles' compute capabilities to function as individual processors of a multi-processor computer system.

### BACKGROUND

### Field of the Disclosure

The present disclosure relates to wireless networks.

### Description of the Related Art

This section introduces aspects that may help facilitate a better understanding of the disclosure. Accordingly, the statements of this section are to be read in this light and are not to be understood as admissions about what is prior art or what is not prior art.

It is known for certain types of vehicles, such as self-driving cars and other electric and hybrid vehicles, to have compute capabilities that enable the vehicle to process data even during idle periods when the vehicle is not being operated. For example, a self-driving car may collect video data while the car is being operated, where the car will continue to process that video data after the car has stopped being operated.

It is also known for these vehicles to have three different types of wireless communication capabilities having three different ranges: short range (e.g., Bluetooth Low Energy (BLE), mid-range (e.g., WiFi), and long range (e.g., cellular). BLE capability enables the vehicle to communicate wirelessly with wireless user equipment (UE), such as the cell phone of the vehicle's operator. WiFi capability enables the vehicle to communicate with the outside world via a WiFi network, such as the operator's home WiFi network when the vehicle is parked at the operator's residence (e.g., in a residential garage), to transmit and receive data or receive programming updates via the Internet to/from remote communication sites, such as servers operated by the vehicle manufacturer. Cellular capability enables the vehicle to communicate with the outside world via a cellular network, such as an LTE and/or 5G network.

When a WiFi network is available, it may be advantageous, e.g., for cost and/or bandwidth reasons, for such a vehicle to communicate with the outside world using its WiFi capability instead of its cellular capability. Unfortunately, when such a vehicle is parked, e.g., in a conventional parking garage, at a location where direct WiFi access is not available, that vehicle will not be able to use its WiFi capability instead of its cellular capability to communicate with the outside world.

### SUMMARY

Problems in the prior art are addressed in accordance with the principles of the present disclosure by technology that enables a vehicle to access the outside work via a WiFi network even when the WiFi network is not directly available to the vehicle.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a diagram representing a wireless network architecture in which four vehicles are parked next to each other in a parking garage having WiFi equipment;

FIG. 2 is a flow diagram of the processing implemented at each vehicle to establish the wireless network architecture of FIG. 1;

FIG. 3 is another representation of the wireless network architecture of FIG. 1 that graphically indicates the current compute capacities and battery-charge levels for each vehicle; and

FIG. 4 is a simplified hardware block diagram of an example node that can be used to implement any of the nodes of FIG. 1.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

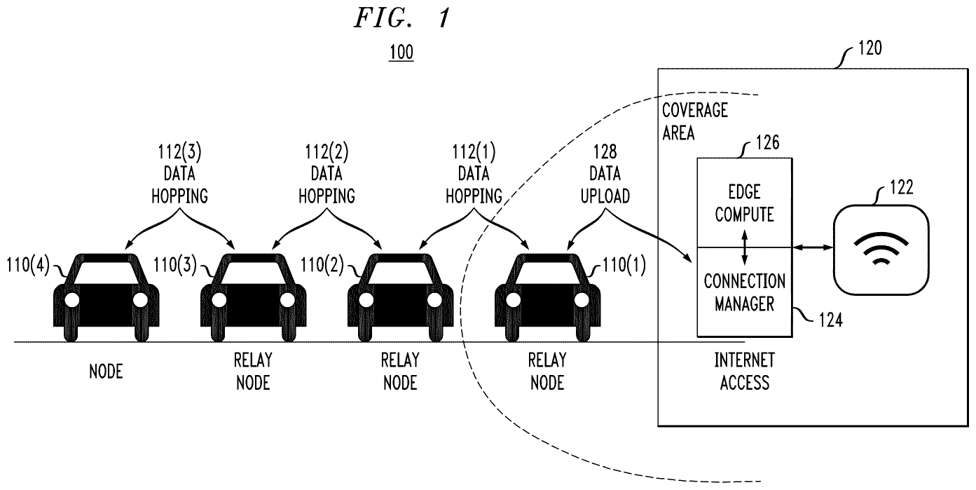

FIG. 1 is a diagram representing a wireless network architecture 100 in which four vehicles 110(1)-110(4) are parked next to each other in a parking garage having WiFi equipment 120 comprising a conventional WiFi access point (AP) 122, a connection manager 124, and an edge compute node 126. As represented in FIG. 1, vehicle 110(1) communicates (i) with the outside world via a WiFi connection 128 with the WiFi equipment 120 and (ii) with vehicle 110(2) via a first BLE connection 112(1). In addition, vehicle 110(2) communicates with vehicle 110(3) via a second BLE connection 112(2), and vehicle 110(3) communicates with vehicle 110(4) via a third BLE connection 112(3). Note that, in this situation, none of vehicles 110(2)-110(4) is close enough to the WiFi equipment 120 to communicate with the outside world via a direct connection with the WiFi equipment 120. Likewise, vehicle 110(1) is too far away from vehicles 110(3) and 110(4) to have a BLE connection with either of those vehicles, and vehicle 110(2) is too far away from vehicle 110(4) to have a BLE connection with that vehicle.

Although vehicle 110(2) does not have a direct WiFi connection with the WiFi equipment 120, vehicle 110(2) can communicate with the outside world indirectly via its BLE connection with vehicle 110(1) and vehicle 110(1)'s WiFi connection. Similarly, vehicle 110(3) can communicate with the outside world indirectly via its BLE connection with vehicle 110(2), vehicle 110(2)'s BLE connection with vehicle 110(1), and vehicle 110(1)'s WiFi connection. Likewise, vehicle 110(4) can communicate with the outside world indirectly via its BLE connection with vehicle 110(3), vehicle 110(3)'s BLE connection with vehicle 110(2), vehicle 110(2)'s BLE connection with vehicle 110(1), and vehicle 110(1)'s WiFi connection.

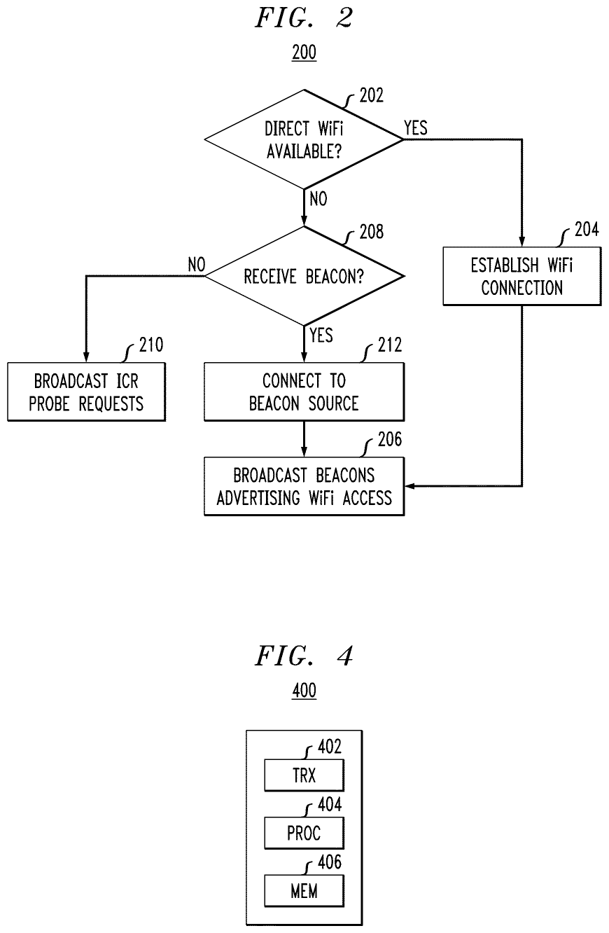

FIG. 2 is a flow diagram of the processing 200 implemented at each vehicle 110 to establish the wireless network architecture 100 of FIG. 1. In step 202, the vehicle 110 determines whether a direct WiFi connection is available at vehicle 110. If so, then, in step 204, the vehicle 110 establishes a WiFi connection, e.g., with the WiFi equipment 120 of FIG. 1. In step 206, as long as the WiFi connection remains, the vehicle 110 transmits a continuous series of special BLE beacon messages indicating that it has WiFi access, in this case, direct WiFi access. If, however, the vehicle 110 determines, in step 202, that a direct WiFi connection is not available at vehicle 110, then processing proceeds to step 208.

In step 208, the vehicle 110 determines whether it has received a special BLE beacon message from another vehicle indicating that that other vehicle has (direct or indirect) WiFi access. If not, then, in step 210, the vehicle 110 transmits an intermediate connectivity request (ICR) probe message to help build a router to reach a vehicle with Internet access. If, however, the vehicle 110 determines in step 208 that it has received such a BLE beacon message, then, in step 212, the vehicle 110 establishes a BLE connection with the other vehicle that transmitted that special BLE beacon message. Processing then continues to step 206, where the vehicle 110 begins to transmit a continuous series of BLE beacon messages indicating that it has WiFi access, in this case, indirect WiFi access via that other vehicle and possibly one or more additional vehicles.

Assume a scenario in which vehicles 110(2)-110(4) are already parked in the parking garage of FIG. 1 and implementing the processing 200 of FIG. 2. Because all of vehicles 110(2)-110(4) are too far away from the WiFi equipment 120 to establish a direct WiFi connection, step 202 at each vehicle produces a negative result and, since no vehicles will be transmitting the special BLE beacon messages, step 208 at each vehicle also produces a negative result, such that nothing happens at any of vehicles 110(2)-110(4).

Now assume that vehicle 110(1) arrives at the parking garage, parks in the spot represented in FIG. 1, and implements the processing 200 of FIG. 2. At step 202, vehicle 110(1) determines that a direct WiFi connection is available. As such, at step 204, vehicle 110(1) establishes the direct WiFi connection 128 of FIG. 1 with the WiFi equipment 120 and, at step 206, vehicle 110(1) starts to transmit the special BLE beacon messages.

Meanwhile, at vehicle 110(2), step 202 continues to produce a negative result, but now, at step 208, vehicle 110(2) begins to receive the special BLE beacon messages transmitted by vehicle 110(1). As such, at step 212, vehicle 110(2) establishes the direct BLE connection 112(1) of FIG. 1 with vehicle 110(1) and, at step 206, vehicle 110(2) begins to transmit its own special BLE beacon messages.

Meanwhile, at vehicle 110(3), step 202 continues to produce a negative result, but now, at step 208, vehicle 110(3) begins to receive the special BLE beacon messages transmitted by vehicle 110(2). As such, at step 212, vehicle 110(3) establishes the direct BLE connection 112(2) of FIG. 1 with vehicle 110(2) and, at step 206, vehicle 110(3) begins to transmit its own special BLE beacon messages.

Lastly, at vehicle 110(4), step 202 continues to produce a negative result, but now, at step 208, vehicle 110(4) begins to receive the special BLE beacon messages transmitted by vehicle 110(3). As such, at step 212, vehicle 110(4) establishes the direct BLE connection 112(3) of FIG. 1 with vehicle 110(3) and, at step 206, vehicle 110(4) begins to transmit its own special BLE beacon messages.

At this point, the wireless network architecture 100 shown in FIG. 1 will have been established, providing each of vehicles 110(1)-110(4) with access to the outside world via the WiFi equipment 120 and without having to use its cellular capability.

Note that, if the collection of vehicles 110 changes over time, the wireless network architecture 100 is dynamically and automatically adjusted accordingly. For example, if a fifth vehicle (not shown) parks on the other side of vehicle 110(4) and implements the processing 200 of FIG. 2, that fifth vehicle will (i) begin to receive the special BLE beacon messages transmitted by vehicle 110(4), (ii) establish its own BLE connection to vehicle 110(4), thereby gaining access to the outside world via the WiFi equipment 120, and (iii) begin to transmit its own special BLE beacon messages.

If vehicle 110(3) leaves the garage, then, in the situation described above for FIG. 1, vehicle 110(4) will lose its access to the outside world via the WiFi equipment 120. If and when another vehicle parks in that empty spot and implements the processing 200 of FIG. 2, vehicle 110(4) will eventually regain its access to the outside world via the WiFi equipment 120 with that new vehicle replacing vehicle 110(3) in a modified version of the wireless network architecture 100 of FIG. 1. Similarly, if vehicle 110(1) leaves the garage, then all of vehicles 110(1)-110(3) will lose their WiFi access to the outside world until another similar vehicle replaces vehicle 110(1) and enables another modified version of the wireless network architecture 100 to be established with that new vehicle in place of vehicle 110(1).

Although FIG. 1 shows a single row consisting of four vehicles 110(1)-110(2), in which vehicles 110(1) and 110(4) each have a single BLE connection 112 and vehicles 110(2) and 110(3) each have two BLE connections 112, those skilled in the art will understand that other wireless network architectures of the present disclosure may have one-, two-, or even three-dimensional distributions of vehicles 110 in which each vehicle may independently have one, two, or more BLE connections 112 to one, two, or more other vehicles. As known to those skilled in the art, BLE technology is designed to allow a device to establish multiple connections simultaneously, although the exact number of connections supported can vary depending on factors such as the BLE chip used, the firmware, and the resources available on the device. In such cases, there may be multiple, different, possible transmission paths through the collection of vehicles between a given vehicle and the WiFi equipment 120, including one or more vehicles with direct WiFi connections to the WiFi equipment 120. In some embodiments, the connection manager 124 of the WiFi equipment 120 is responsible for dynamically selecting a single transmission path to the WiFi equipment 120 for each different vehicle using such real-time criteria as signal strengths, latencies, error rates, bandwidth needs, distances in terms of number of hops, characteristics of the vehicle batteries, and QoS requirements, including the ability to dynamically modify those selected transmission paths as vehicles enter and leave the collection of vehicles.

As described above, each vehicle 110 has compute capabilities that enable the vehicle to perform data processing even during idle periods when the vehicle is not being operated. According to certain embodiments, the edge compute node 126 orchestrates the compute capabilities of the vehicles 110 in the wireless network architecture 100 to enable the vehicles to function individually as processors of a multi-processor computer system corresponding to all of the vehicles' compute capabilities combined.

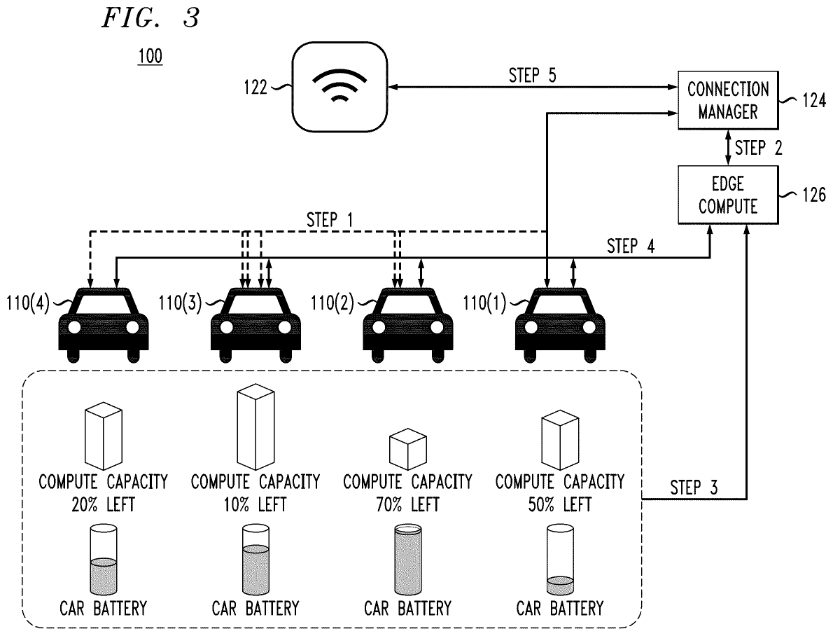

FIG. 3 is another representation of the wireless network architecture 100 of FIG. 1 that graphically indicates the current compute capacities and battery-charge levels for each vehicle 110. In step 1 of FIG. 3, the wireless network architecture 100 is established as described above in the context of each vehicle 110 implementing the processing 200 of FIG. 2. In step 2, the connection manager 124 identifies the different vehicles 110(1)-110(4) in the wireless network architecture 100 to the edge compute node 126. In step 3, each vehicle 110 reports their own compute capacity and battery-charge level to the edge compute node 126. In step 4, the edge compute node 126 uses that information to function as the controller for a multi-processor computer system distributing specific processing tasks to specific processors (i.e., the different vehicles 110). In step 5, the edge compute node 126 gathers and collates the results from the vehicles 110 and communicates the results with the outside world via the connection manager 124 and the WiFi AP 122.

As just one possible example, assume that vehicle 110(1) has video data that needs to be processed. Unfortunately, since vehicle 110(1) has very little battery charge left, vehicle 110(1) might be unable to process its video data successfully. In that case, the edge compute node 126 may redistribute some or all of that video data processing to one or more of the other vehicles, such as vehicle 110(2), which has more compute capacity and more battery charge than vehicle 110(1). The edge compute node 126 will combine the results from the various vehicles 110 and present the combined results to vehicle 110(1) in a form equivalent to the results produced by vehicle 110(1) performing all of that processing by itself. In this way, one or more of vehicles 110(2)-110(4) may assist in the processing of vehicle 110(1)'s video data. Those skilled in the art will understand that any suitable data processing can be shared among the vehicles 110 as orchestrated by the edge compute node 126.

FIG. 4 is a simplified hardware block diagram of an example node 400 that can be used to implement any of the nodes 110, 120 of FIG. 1. As shown in FIG. 4, the node 400 includes (i) communication hardware (e.g., wireless, wireline, and/or optical transceivers (TRX)) 402 that supports communications with other nodes, (ii) one or more processors (e.g., CPU and/or GPU microprocessors) 404 that control the operations of the node 400 and/or process data within the node 400, and (iii) one or more memories (e.g., RAM, ROM) 406 that store code executed by the processors 404 and/or data generated and/or received by the node 400.

When used to implement a vehicle 110 of FIG. 1, the communication hardware 402 of node 400 will include a BLE module that handles BLE communications, including the BLE communications with other vehicles 110, and a WiFi module that handles WiFi communications, including the WiFi communications of vehicle 110(1) with WiFi equipment 120. In addition, node 400 will include a processor 404 that can convert incoming BLE signals that conform to a suitable BLE communication protocol into outgoing WiFi signals that conform to a suitable WiFi communication protocol such as Message Queuing Telemetry Transport (MQTT) or Hypertext Transfer Protocol (HTTP), and vice versa for incoming WiFi signals and outgoing BLE signals, as in vehicle 110(1).

Although the disclosure has been described in the context of wireless network architectures involving WiFi as a mid-range wireless protocol that provides direct access to the outside world and BLE as a short-range wireless protocol that provides indirect access to the outside world, those skilled in the art will understand that other embodiments may involve other suitable wireless protocols including, without limitation, Zigbee, Z-Wave, Thread, and/or LoRaWan.

In certain embodiments, the present disclosure is a method for a second vehicle achieving outside-world access. The method comprises the second vehicle determining whether the second vehicle has received a first-vehicle beacon from a first vehicle indicating that the first vehicle has outside-world access. Upon the second vehicle determining that the second vehicle has received the first-vehicle beacon, the second vehicle establishes a first wireless connection with the first vehicle to provide the second vehicle with the outside-world access via the first vehicle and transmits a second-vehicle beacon message indicating that the second vehicle has the outside-world access.

In at least some of the above embodiments, the method further comprises the second vehicle establishing, while maintaining the first wireless connection, a second wireless connection with a third vehicle that received the second-vehicle beacon message to provide the third vehicle with the outside-world access via the second vehicle and the first vehicle.

In at least some of the above embodiments, the first-vehicle beacon message and the second-vehicle beacon message are Bluetooth transmissions; the first wireless connection between the first and second vehicles is a Bluetooth connection; and the outside-world access is provided by at least the Bluetooth connection and a WiFi connection to a WiFi access point (AP).

In at least some of the above embodiments, the method further comprises, prior to determining whether the second vehicle has received the first-vehicle beacon, the second vehicle determining whether the second vehicle has outside-world access that does not involve an intervening vehicle. Upon the second vehicle determining that the second vehicle has the outside-world access that does not involve an intervening vehicle, the second vehicle establishes a wireless connection with an outside-world access point to provide the second vehicle with the outside-world access that does not involve an intervening vehicle and transmits a second-vehicle beacon message indicating that the second vehicle has the outside-world access.

In at least some of the above embodiments, the method further comprises the second vehicle establishing a wireless connection with a third vehicle that received the second-vehicle beacon message to provide the third vehicle with outside-world access via the second vehicle.

In at least some of the above embodiments, the second-vehicle beacon message is a Bluetooth transmission, and the outside-world access point is a WiFi AP.

In at least some of the above embodiments, the method further comprises the second vehicle providing information about the second vehicle to an outside-world access point to which the vehicles are directly or indirectly wirelessly connected.

In at least some of the above embodiments, the information comprises at least one of the second vehicle's compute capacity and the second vehicle's battery charge level.

In at least some of the above embodiments, the method further comprises the second vehicle receiving and executing compute instructions from the outside-world access point.

In certain embodiments, the present disclosure is a method for outside-world access-point equipment controlling vehicle compute capabilities. The method comprises the outside-world access-point equipment receiving information about vehicles in a wireless network architecture, wherein each vehicle has compute capability and orchestrating the compute capabilities of the vehicles to function as individual processors of a multi-processor computer system.

In at least some of the above embodiments, the information about each vehicle comprises at least one of the vehicle's compute capacity and the vehicle's battery charge level.

In at least some of the above embodiments, the method further comprises the outside-world access-point equipment instructing a second vehicle to process data of a first vehicle.

In at least some of the above embodiments, the outside-world access-point equipment comprises a WiFi AP that communicates directly with a first vehicle via a WiFi connection and indirectly with one or more other vehicles via the WiFi connection and one or more vehicle-to-vehicle Bluetooth connections.

In at least some of the above embodiments, the method further comprises the outside-world access-point equipment determining a corresponding path through the wireless network architecture between the outside-world access-point equipment and each vehicle.

In at least some of the above embodiments, the method further comprises the outside-world access-point equipment dynamically modifying the path to a first vehicle upon a second vehicle leaving the wireless network architecture.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure.

As used herein in reference to an element and a standard, the terms “compatible” and “conform” mean that the element communicates with other elements in a manner wholly or partially specified by the standard and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A method for a second vehicle achieving outside-world access, the method comprising the second vehicle:
determining whether the second vehicle has received a first-vehicle beacon from a first vehicle indicating that the first vehicle has outside-world access; and
upon the second vehicle determining that the second vehicle has received the first-vehicle beacon:
establishing a first wireless connection with the first vehicle to provide the second vehicle with the outside-world access via the first vehicle; and
transmitting a second-vehicle beacon message indicating that the second vehicle has the outside-world access.

2. The method of claim 1, further comprising the second vehicle:
establishing, while maintaining the first wireless connection, a second wireless connection with a third vehicle that received the second-vehicle beacon message to provide the third vehicle with the outside-world access via the second vehicle and the first vehicle.

3. The method of claim 1, wherein:
the first-vehicle beacon message and the second-vehicle beacon message are Bluetooth transmissions;
the first wireless connection between the first and second vehicles is a Bluetooth connection; and
the outside-world access is provided by at least the Bluetooth connection and a WiFi connection to a WiFi access point (AP).

4. The method of claim 1, further comprising, prior to determining whether the second vehicle has received the first-vehicle beacon, the second vehicle:
determining whether the second vehicle has outside-world access that does not involve an intervening vehicle;
upon the second vehicle determining that the second vehicle has the outside-world access that does not involve an intervening vehicle:
establishing a wireless connection with an outside-world access point to provide the second vehicle with the outside-world access that does not involve an intervening vehicle; and
transmitting a second-vehicle beacon message indicating that the second vehicle has the outside-world access.

5. The method of claim 4, further comprising the second vehicle:
establishing a wireless connection with a third vehicle that received the second-vehicle beacon message to provide the third vehicle with outside-world access via the second vehicle.

6. The method of claim 4, wherein:
the second-vehicle beacon message is a Bluetooth transmission; and
the outside-world access point is a WiFi AP.

7. The method of claim 1, further comprising the second vehicle providing information about the second vehicle to an outside-world access point to which the vehicles are directly or indirectly wirelessly connected.

8. The method of claim 7, wherein the information comprises at least one of the second vehicle's compute capacity and the second vehicle's battery charge level.

9. The method of claim 7, further comprising the second vehicle receiving and executing compute instructions from the outside-world access point.

10. A second vehicle comprising:
a memory; and
at least one processor, coupled to the memory and operative to cause the second vehicle to:
determine whether the second vehicle has received a first-vehicle beacon from a first vehicle indicating that the first vehicle has outside-world access; and
upon the second vehicle determining that the second vehicle has received the first-vehicle beacon:
establish a first wireless connection with the first vehicle to provide the second vehicle with outside-world access via the first vehicle; and
transmit a second-vehicle beacon message indicating that the second vehicle has the outside-world access.

11. The second vehicle of claim 10, wherein the second vehicle is further adapted to:
establish, while maintaining the first wireless connection, a second wireless connection with a third vehicle that received the second-vehicle beacon message to provide the third vehicle with the outside-world access via the second vehicle and the first vehicle.

12. The second vehicle of claim 10, wherein:
the first-vehicle beacon message and the second-vehicle beacon message are Bluetooth transmissions;
the first wireless connection between the first and second vehicles is a Bluetooth connection; and
the outside-world access is provided by at least the Bluetooth connection and a WiFi connection to a WiFi access point (AP).

13. The second vehicle of claim 10, wherein the second vehicle is further adapted to, prior to determining whether the second vehicle has received the first-vehicle beacon:
determine whether the second vehicle has the outside-world access that does not involve an intervening vehicle;
upon the second vehicle determining that the second vehicle has the outside-world access that does not involve an intervening vehicle:
establish a wireless connection with an outside-world access point to provide the second vehicle with the outside-world access that does not involve an intervening vehicle; and
transmit a second-vehicle beacon message indicating that the second vehicle has the outside-world access.

14. The second vehicle of claim 13, wherein the second vehicle is further adapted to:
establish a wireless connection with a third vehicle that received the second-vehicle beacon message to provide the third vehicle with outside-world access via the second vehicle.

15. The second vehicle of claim 13, wherein:
the second-vehicle beacon message is a Bluetooth transmission; and
the outside-world access point is a WiFi AP.

16. The second vehicle of claim 10, wherein the second vehicle is adapted to provide information about the second vehicle to an outside-world access point to which the vehicles are directly or indirectly wirelessly connected.

17. The second vehicle of claim 16, wherein the information comprises at least one of the second vehicle's compute capacity and the second vehicle's battery charge level.

18. The second vehicle of claim 16, wherein the second vehicle is adapted to receive and execute compute instructions from the outside-world access point.

19. A method for outside-world access-point equipment controlling vehicle compute capabilities, the method comprising the outside-world access-point equipment:
receiving information about vehicles in a wireless network architecture, wherein each vehicle has compute capability; and
orchestrating the compute capabilities of the vehicles to function as individual processors of a multi-processor computer system.

20. The method of claim 19, wherein the information about each vehicle comprises at least one of the vehicle's compute capacity and the vehicle's battery charge level.

21. The method of claim 19, further comprising the outside-world access-point equipment instructing a second vehicle to process data of a first vehicle.

22. The method of claim 19, wherein the outside-world access-point equipment comprises a WiFi AP that communicates directly with a first vehicle via a WiFi connection and indirectly with one or more other vehicles via the WiFi connection and one or more vehicle-to-vehicle Bluetooth connections.

23. The method of claim 19, further comprising the outside-world access-point equipment determining a corresponding path through the wireless network architecture between the outside-world access-point equipment and each vehicle.

24. The method of claim 23, further comprising the outside-world access-point equipment dynamically modifying the path to a first vehicle upon a second vehicle leaving the wireless network architecture.

25. Outside-world access-point equipment, comprising:
a memory; and
at least one processor, coupled to the memory and operative to cause the outside-world access-point equipment to:
receive information about vehicles in a wireless network architecture, wherein each vehicle has compute capability; and
orchestrate the compute capabilities of the vehicles to function as individual processors of a multi-processor computer system.

26. The outside-world access-point equipment of claim 25, wherein the information about each vehicle comprises at least one of the vehicle's compute capacity and the vehicle's battery charge level.

27. The outside-world access-point equipment of claim 25, wherein the outside-world access-point equipment is adapted to instruct a second vehicle to process data of a first vehicle.

28. The outside-world access-point equipment of claim 25, wherein the outside-world access-point equipment comprises a WiFi AP that is adapted to communicate directly with a first vehicle via a WiFi connection and indirectly with one or more other vehicles via the WiFi connection and one or more vehicle-to-vehicle Bluetooth connections.

29. The outside-world access-point equipment of claim 25, wherein the outside-world access-point equipment is adapted to determine a corresponding path through the wireless network architecture between the outside-world access-point equipment and each vehicle.

30. The outside-world access-point equipment of claim 29, wherein the outside-world access-point equipment is adapted to dynamically modify the path to a first vehicle upon a second vehicle leaving the wireless network architecture.
